(19) United States
(12) Patent Application Publication
(10) Pub. No.: US 2007/0136758 A1
(43) Pub. Date: Jun. 14, 2007

(54) System, method, mobile terminal and computer program product for defining and detecting an interactive component in a video data stream

(75) Inventors: Juha Lehikoinen, Lakiala (FI); Tero Hakala, Kangasala (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/300,067

(22) Filed: Dec. 14, 2005

(51) Int. Cl. H04N 7/173; H04N 7/16; H04N 5/445; G06F 3/00

(52) U.S. Cl. 725/53; 725/62; 725/52; 725/112; 725/113

(57) ABSTRACT

A mobile terminal for interactively displaying streaming video data includes a processing element. The processing element is capable of defining a selected graphical element as an interactive component and defining a desired action associated with the interactive component. The processing element is also capable of detecting the interactive component in a video data stream and causing the desired action associated with the interactive component to be performed in response to selection of the interactive component.

### FIELD OF THE INVENTION

Embodiments of the present invention relate generally to wireless technology and, more particularly, relate to enabling a mobile terminal to display interactive components.

### BACKGROUND OF THE INVENTION

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to processing and display of video streams at a mobile terminal. Accordingly, digital broadband data broadcast networks have been developed such as, for example, digital video broadcasting (DVB), Japanese Terrestrial Integrated Service Digital Broadcasting (ISDB-T), Digital Audio Broadcasting (DAB), Multimedia Broadcast Multicast Service (MBMS), and those networks provided by the Advanced Television Systems Committee (ATSC). In this regard, digital broadband data broadcast networks enjoy popularity in Europe and elsewhere for the delivery of television content as well as the delivery of other data, such as Internet Protocol (IP) data. Other examples of broadband data broadcast networks include Japanese Terrestrial Integrated Service Digital Broadcasting (ISDB-T), Digital Audio Broadcasting (DAB), and Multimedia Broadcast Multicast Service (MBMS), and those networks provided by the Advanced Television Systems Committee (ATSC).

With the development of improved means for delivery of video data, a demand has grown for services that offer interactive aspects such as systems incorporating aspects of television viewing and internet browsing simultaneously. Furthermore, systems have been developed in which a viewer of a television video stream may interact with graphical items on the television display that link, for example, to an internet website. However, such systems require special modification of the video stream itself in order to enable such functionality. In other words, current systems require that information such as a location, type and other characteristics of the graphical item is transmitted with the data stream. The information is, therefore, predetermined at the transmission side and may be embedded as metadata or a separate stream within a particular program being transmitted. For example, a universal resource locator (URL) may be embedded in the video stream. Accordingly, users are dependent upon the transmission side to determine which graphical items will have functionality associated with them, and often times also, what functionality is associated with the graphical items. Furthermore, a tremendous amount of effort and preparation to produce such functionality is required at the transmission side, making delivery of such services relatively expensive. Additionally, the above described methods are not feasible for certain programs, such as, for example, live broadcasts, sporting events, etc. Thus, a need exists for providing interactive components that need not be transmitted as part of or along with the data stream.

### BRIEF SUMMARY OF THE INVENTION

A system, method, apparatus and computer program product are therefore provided which allows a user of a mobile terminal to define interactive components in an existing video data stream. Thus, interactive components need not be defined at the transmission end and embedded in transmitted data.

According to an exemplary embodiment, a mobile terminal for interactively displaying streaming video data is provided. The mobile terminal includes a processing element that is capable of defining a selected graphical element as an interactive component and defining a desired action associated with the interactive component. The processing element is also capable of detecting the interactive component in a video data stream and causing the desired action associated with the interactive component to be performed in response to selection of the interactive component.

According to an exemplary embodiment, a computer program product for interactively displaying streaming video data at a mobile terminal is provided. The computer program product includes at least one computer-readable storage medium having computer-readable program code portions stored therein. The computer-readable program code portions include first to fifth executable portions. The first executable portion is for defining a selected graphical element as an interactive component. The second executable portion is for defining a desired action associated with the interactive component. The third executable portion is for monitoring a video data stream for the interactive component. The fourth executable portion is for detecting the interactive component in the video data stream. The fifth executable portion for causing the desired action associated with the interactive component to be performed in response to selection of the interactive component.

According to an exemplary embodiment, a method for interactively displaying streaming video data at a mobile terminal is provided. The method includes defining a selected graphical element as an interactive component, defining a desired action associated with the interactive component, monitoring a video data stream for the interactive component, detecting the interactive component in the video data stream, and causing the desired action associated with the interactive component to be performed in response to selection of the interactive component.

According to an exemplary embodiment, a system for interactively displaying streaming video data at a mobile terminal is provided. The system includes a network device and a mobile terminal. The network device is capable of wirelessly transmitting streaming video data. The mobile terminal is in communication with the network device and is capable of wirelessly receiving the streaming video data. The mobile terminal has a processing element capable of defining a selected graphical element as an interactive component and defining a desired action associated with the interactive component. The processing element is also capable of detecting the interactive component in the streaming video data and causing the desired action associated with the interactive component to be performed in response to selection of the interactive component. The interactive component is a user defined element defined entirely at the mobile terminal.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a front view of a mobile terminal according to an exemplary embodiment of the present invention; and

FIG. 4 is a block diagram according to an exemplary method of interactively displaying streaming video data at a display of a mobile terminal.

### DETAILED DESCRIPTION OF THE INVENTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

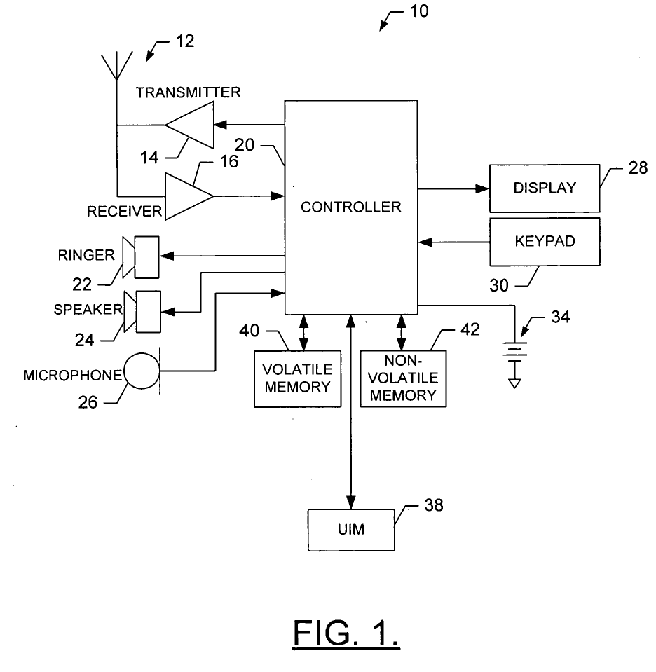

FIG. 1 illustrates a block diagram of a mobile terminal 10 that would benefit from the present invention. It should be understood, however, that a mobile telephone as illustrated and hereinafter described is merely illustrative of one type of mobile terminal that would benefit from the present invention and, therefore, should not be taken to limit the scope of the present invention. While several embodiments of the mobile terminal 10 are illustrated and will be hereinafter described for purposes of example, other types of mobile terminals, such as portable digital assistants (PDAs), pagers, laptop computers and other types of voice and text communications systems, can readily employ the present invention.

In addition, while several embodiments of the method of the present invention are performed or used by a mobile terminal 10, the method may be employed by other than a mobile terminal. Moreover, the system and method of the present invention will be primarily described in conjunction with mobile communications applications. It should be understood, however, that the system and method of the present invention can be utilized in conjunction with a variety of other applications, both in the mobile communications industries and outside of the mobile communications industries.

The mobile terminal 10 includes an antenna 12 in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA).

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example. Also, for example, the controller 20 may be capable of operating a software application capable of creating an authorization for delivery of location information regarding the mobile terminal 10, in accordance with embodiments of the present invention (described below).

The mobile terminal 10 also comprises a user interface including a conventional earphone or speaker 22, a ringer 24, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 includes the conventional numeric (0-9) and related keys (#, *), and other keys used for operating the mobile terminal 10. The mobile terminal 10 further includes a battery 34, such as a vibrating battery pack, for powering various circuits that are required to operate the mobile terminal 10, as well as optionally providing mechanical vibration as a detectable output. The mobile terminal 10 may further include a universal identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

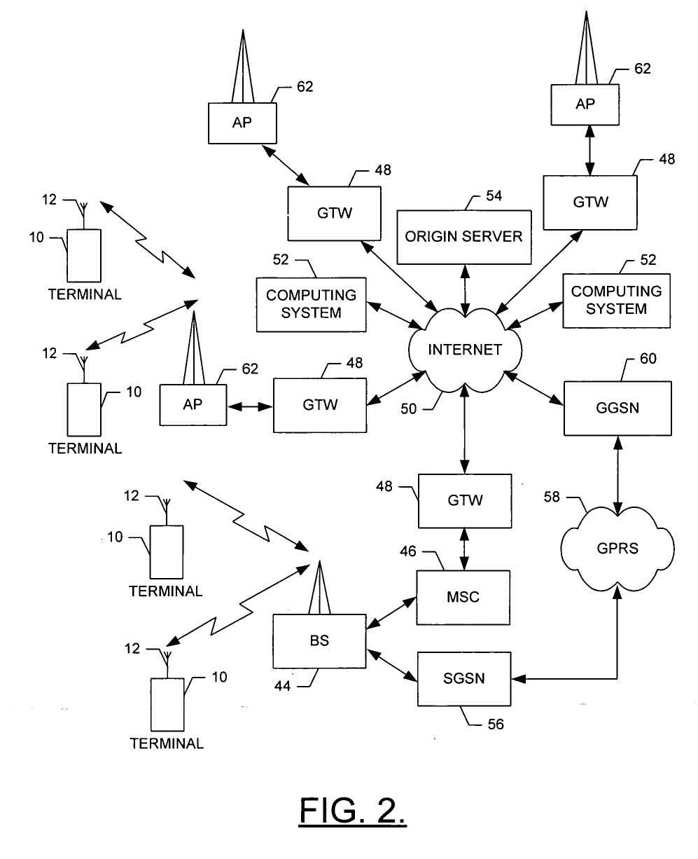

Referring now to FIG. 2, an illustration of one type of system that would benefit from the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and the present invention is not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

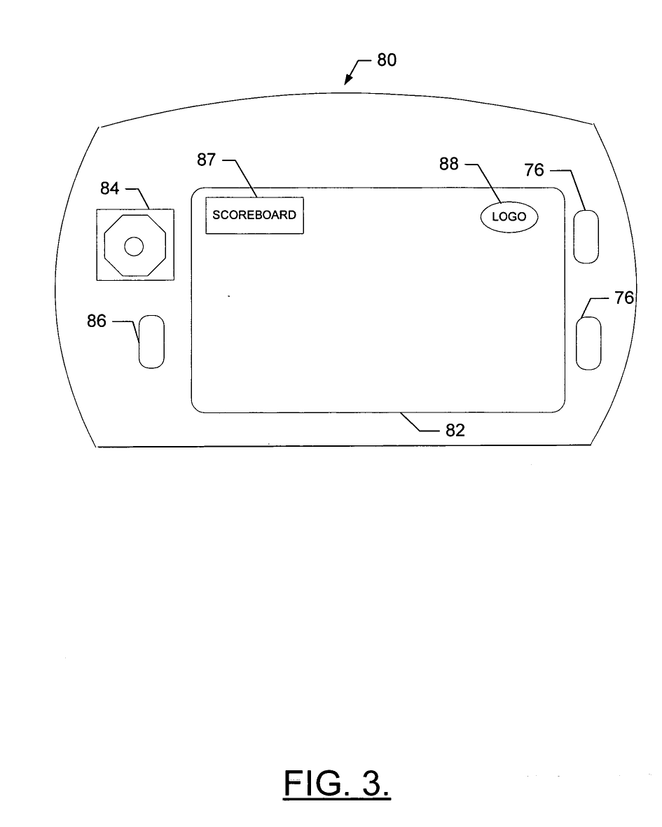

Although an exemplary embodiment of the invention will now be described with reference to FIG. 3, it should be noted that the mobile terminal 10 of FIG. 1 and numerous other mobile terminals may also be used to implement the present invention. Reference is now made to FIG. 3, which illustrates a front view of a mobile terminal 80 in accordance with an exemplary embodiment of the present invention. Unlike the embodiment described with reference to FIG. 1, the mobile terminal 80 of this exemplary embodiment does not employ a keypad. Instead, the mobile terminal 80 includes a display 82 and a user interface. The user interface includes a touch pad 84 and various push buttons 86, which may be manipulated in order to select an interactive component. The touch pad 84 may be used to scroll an interface device such as a cursor over the display 82 in order to select items, for example, from a menu or by clicking on items displayed on the display 82. For example, the touch pad 84 may be manipulated until the cursor is disposed over the interactive component and clicked. Alternatively, if the display 82 includes a touch screen, a pen, a finger or other implement may be used to click on and select the interactive component. In response to selection of the interactive component, by clicking or any other suitable mechanism, a user defined function associated with the interactive component may be accessed.

The interactive component may be, for example, a scoreboard 87, a channel logo 88, or any other user defined graphical element that is capable of initiating performance of a function predefined at a client side upon selection. The interactive component provides a mechanism by which a user may interactively influence either data displayed on the display 82 or functions performed by the mobile terminal 80. The interactive component may be a button that provides a link to a specific website or URL, a link to access a predefined functionality, a link to stored information, etc. For example, the channel logo 88 may be defined by the user to provide a link to more information on the current program, the channel settings, program times, etc. In the context of a live telecast of a sporting event, the scoreboard 88, for example, may provide a link to more comprehensive game statistics, betting sites, etc. Although the scoreboard 87 and the logo 88 are listed above as examples of the interactive component, it should be noted that any graphical element that is detectable and accessible within a stream of video data can act as the interactive component. Accordingly, the interactive component need not be a fixed object. Rather, the interactive component may be any fixed or moving object, so long as the object is recognizable as the interactive component. Similarly, a size of the interactive component may be variable so long as the interactive component is recognizable. Furthermore, it should be noted that any function may be associated with the interactive component, including functions that are not intuitively associated with the interactive component. For example, clicking on the logo 88 may cause an address book of a user of the mobile terminal 80 to be opened, or a text message to be sent, etc., even though those functions do not otherwise have any relationship to the logo 88.

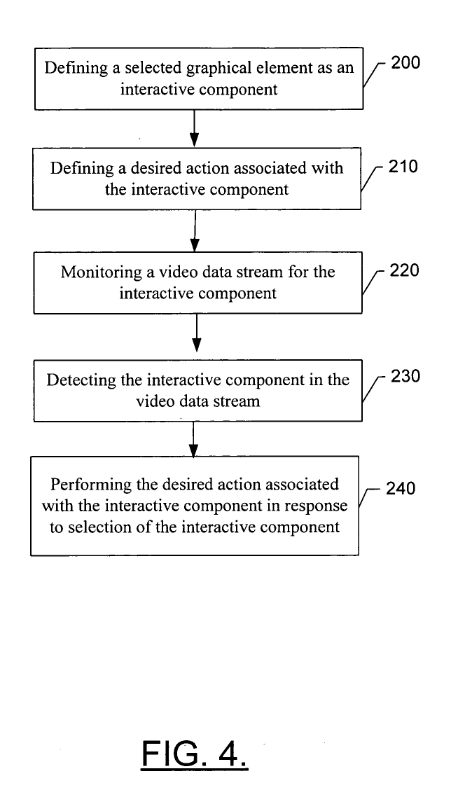

As stated above, the interactive component is user defined. Thus, all necessary means to define the interactive component are available at or otherwise accessible by the mobile terminal 80. In an exemplary embodiment, a software program containing instructions for defining a graphical element as the interactive component are stored in a memory of the mobile terminal 80 and executed by a controller of the mobile terminal 80. In order to designate a graphical item as an interactive component, the user must define both a selected graphical item and a desired action to be associated with the selected graphical element as described below with reference to FIG. 4.

FIG. 4 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for interactively displaying streaming video data at a mobile terminal includes defining a selected graphical element as an interactive component at operation 200. The selected graphical elements may be predefined and stored in a library, for example. However, the selected graphical elements are not transmitted as a part of a data stream received by the mobile terminal 80 and are defined independently of the network side. The selected graphical element may defined by causing the mobile terminal 80 to learn a specific shape using, for example, a pattern recognition program. A pattern may be recognized by such pattern recognition when the selected graphical element is repeated and subsequently recognized. For example, a user at the client side may use the cursor to select a selected graphical element appearing on the display 82 using a click and drag operation to define the selected graphical element as an interactive component. In some instances, it may be necessary for the user to reselect and redefine the selected graphical element as an interactive component if the selected shape appears again and is not identified by the mobile terminal 80 as the interactive component. In other words if detection capability, discussed in greater detail below, is lacking, it may be an indication that the selected graphical element has not been properly learned. Such a case may occur if the selected graphical element is mobile, changes aspect, color, size, etc., and redefinition may assist the mobile terminal 80 in learning the selected graphical element as the interactive component and enhance detection. The selected graphical element may be an object, a character, group of characters, a graphic or combination of graphics. Additionally, some parts of the selected graphical element may be characters while other parts are graphics. In addition to learning a shape or pattern of the selected graphical element, other required characteristics may also be learned. For example, a type of program in which the selected graphical element may be found can be associated with the interactive component. Accordingly, the mobile terminal 80 would only perform a search for the selected graphical element in response to receipt of video data corresponding to the type of program that is associated with the interactive component. Additionally, a particular layout pattern or location for the selected graphical element may be assigned, thereby further limiting functionality of the interactive component to situations where the selected graphical element appears, for example, in a particular location or in a particular layout such as with a specific border, font, color, size, etc.

In an exemplary embodiment, a storage device may be employed to store a list of user defined interactive components including any of, for example, the selected graphical element designed to represent each interactive component, program types in which the interactive component is expected to be found, any expected color, size, shape or location of the selected graphical element, etc.

At operation 210, a desired action associated with the interactive component is defined. In other words, once the selected graphical element has been learned as an interactive component, a function is assigned to be performed when the interactive component is selected. For example, following selection of the selected graphical element using the click and drag operation described above, an application run on the mobile terminal 80 may provide a menu from which a selection can be made to designate a function to associate with the interactive component. Once the selected graphical element, any characteristics associated with the selected graphical element and the action to be associated with the selected graphical element have been defined, the interactive component has been defined.

When the interactive component has been defined, monitoring of the video data stream may be performed at operation 220. While monitoring the video data stream, the mobile terminal 80 is searching for interactive components in order to assign associated functionality to each interactive component identified in the video data stream.

During monitoring of the video data stream, the interactive component may be detected in the video data stream at operation 230. Interactive components may be detected by a probability function which associates similar patterns based on a probability that a subsequent shape is the selected graphical element associated with a particular interactive component. Detection of the interactive component occurs responsive to a search for the interactive component within a detection space. The detection space, which defines an area of the display 82 to be searched for the interactive component, may be coextensive with the video data stream that is received or it may be narrowed. For example, the detection space may be limited to a particular location at which the interactive component is expected or to only those programs in which the interactive component is expected to be displayed. For example, the scoreboard 87 may be associated only with sporting events, or even a particular sporting event. Additionally, the scoreboard 87 may be associated only with a location in an upper left corner of the display 82. Accordingly, in programs other than the particular sporting event, or in data representative of images at locations other than the upper left corner of the display 82, the scoreboard 87 will not be detected and would not be recognized at an interactive component. Furthermore, no search will be conducted in areas outside the search area thereby increasing efficiency of processing and decreasing a demand on processing resources. Associations between particular programs, locations, layouts, etc. to be searched for interactive components and particular interactive components which are expected to be found in the particular programs, locations, layouts, etc. may be stored in a memory device of the mobile terminal 80 and may be accessed, in one embodiment, by a controller of the mobile terminal 80 upon execution of the computer program that provides the search functionality and detection.

At operation 240, the desired action associated with the interactive component is performed in response to user selection of the interactive component. For example, when the user clicks on the scoreboard 87, more detailed game statistics are provided. In this example, the mobile terminal 80 may request the updated and additional statistics from a server (transmission side) which then provides the information (if available) for display at the mobile terminal 80. Accordingly, the user is able to define interactive components in an incoming video data stream and define functionality to be associated with the interactive components independent of links or instructions embedded in the incoming video data.

The above described functions may be carried out in many ways. For example, any suitable means for carrying out each of the functions described above may be employed to carry out the invention. In one embodiment, a computer program stored in a memory device of the mobile terminal is executed by the controller to define interactive components and subsequently search for, display and respond to actuation of the interactive components.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A mobile terminal for interactively displaying streaming video data, the mobile terminal comprising:
a processing element capable of defining a selected graphical element as an interactive component and defining a desired action associated with the interactive component, the processing element also being capable of detecting the interactive component in a video data stream and causing the desired action associated with the interactive component to be performed in response to selection of the interactive component.

2. The mobile terminal of claim 1, wherein the processing element is configured to detect a specific interactive component responsive to a type of program of the video data stream associated with the specific interactive component.

3. The mobile terminal of claim 1, wherein the processing element is configured to detect a specific interactive component responsive to a location of the specific interactive component on a display of the mobile terminal.

4. The mobile terminal of claim 1, wherein the processing element is configured to detect a specific interactive component responsive to a layout of the specific interactive component.

5. The mobile terminal of claim 1, wherein the processing element is configured to learn a shape of the selected graphical element using pattern recognition.

6. The mobile terminal of claim 5, wherein the processing element is capable of detecting the interactive component responsive to a probabilistic determination that a particular graphical element is the selected graphical element.

7. The mobile terminal of claim 1, further comprising a display,
wherein the processing element is capable of directing the display to present the interactive component as a fixed object.

8. The mobile terminal of claim 1, further comprising a display,
wherein the processing element is capable of directing the display to present the interactive component as a moving object.

9. A computer program product for interactively displaying streaming video data at a mobile terminal, the computer program product comprising at least one computer-readable storage medium having computer-readable program code portions stored therein, the computer-readable program code portions comprising:
a first executable portion for defining a selected graphical element as an interactive component;
a second executable portion for defining a desired action associated with the interactive component;
a third executable portion for monitoring a video data stream for the interactive component;
a fourth executable portion for detecting the interactive component in the video data stream; and
a fifth executable portion for causing the desired action associated with the interactive component to be performed in response to selection of the interactive component.

10. The computer program product of claim 9, wherein the fourth executable portion is further capable of detecting a specific interactive component responsive to a type of program associated with the specific interactive component.

11. The computer program product of claim 9, wherein the fourth executable portion is further capable of detecting a specific interactive component responsive to a location of the specific interactive component on a display of the mobile terminal.

12. The computer program product of claim 9, wherein the fourth executable portion is further capable of detecting a specific interactive component responsive to a layout of the specific interactive component.

13. The computer program product of claim 9, further comprising a sixth executable portion for learning a shape of the selected graphical element using pattern recognition.

14. The computer program product of claim 13, wherein the fourth executable portion is further capable of performing a probabilistic determination to determine if a particular graphical element is the selected graphical element.

15. A method for interactively displaying streaming video data at a mobile terminal, the method comprising:
defining a selected graphical element as an interactive component;
defining a desired action associated with the interactive component;
monitoring a video data stream for the interactive component;
detecting the interactive component in the video data stream; and
causing the desired action associated with the interactive component to be performed in response to selection of the interactive component.

16. The method of claim 15, wherein detecting the interactive component further comprises detecting a specific interactive component responsive to a type of program associated with the specific interactive component.

17. The method of claim 15, wherein detecting the interactive component further comprises detecting a specific interactive component responsive to a location of the specific interactive component on a display of the mobile terminal.

18. The method of claim 15, further comprising learning a shape of the selected graphical element using pattern recognition.

19. The method of claim 18, wherein detecting the interactive component further comprises performing a probabilistic determination to determine if a particular graphical element is the selected graphical element.

20. A system for interactively displaying streaming video data at a mobile terminal, the system comprising:
a network device capable of wirelessly transmitting streaming video data; and
a mobile terminal in communication with the network device and capable of wirelessly receiving the streaming video data, the mobile terminal having a processing element capable of defining a selected graphical element as an interactive component and defining a desired action associated with the interactive component, the processing element also being capable of detecting the interactive component in the streaming video data and causing the desired action associated with the interactive component to be performed in response to selection of the interactive component,
wherein the interactive component is a user defined element defined entirely at the mobile terminal.

21. The system of claim 20, wherein the processing element is configured to detect a specific interactive component responsive to a type of program associated with the specific interactive component.

22. The system of claim 20, wherein the processing element is capable of detecting the interactive component by performing a probabilistic determination that a particular graphical element is the selected graphical element.

23. A mobile terminal for interactively displaying streaming video data, the mobile terminal comprising:
a processing element capable of defining a selected graphical element as an interactive component and defining a desired action associated with the interactive component,
wherein the interactive component is a graphical element defined at the client side and independent of the network side.

24. The mobile terminal of claim 23, wherein the processing element is capable of detecting the interactive component in a video data stream and causing the desired action associated with the interactive component to be performed in response to selection of the interactive component.

25. The mobile terminal of claim 24, wherein the processing element is configured to detect a specific interactive component responsive to a type of program of the video data stream associated with the specific interactive component.

26. The mobile terminal of claim 24, wherein the processing element is capable of detecting the interactive component responsive to a probabilistic determination that a particular graphical element is the selected graphical element.
